(19) United States
(12) Patent Application Publication
(10) Pub. No.: US 2023/0030339 A1
(43) Pub. Date: Feb. 2, 2023

(54) METHOD FOR SLICE QUOTA MANAGEMENT

(71) Applicant: ZTE Corporation, Shenzhen (CN)

(72) Inventors: Jinguo Zhu, Shenzhen (CN); Shuang Liang, Shenzhen (CN); Fei Lu, Shenzhen (CN)

(21) Appl. No.: 17/962,972

(22) Filed: Oct. 10, 2022

Related U.S. Application Data
(63) Continuation of application No. PCT/CN2020/084155, filed on Apr. 10, 2020.

(51) Int. Cl. H04W 48/06; H04W 28/02

(52) U.S. Cl. CPC H04W 48/06; H04W 28/0284

(57) ABSTRACT

Methods, apparatuses, and systems for providing management of network slices are disclosed. In one aspect, a wireless communication method is disclosed. The method includes receiving, by a network side function operating in a wireless network in which network services are provided as one or more network slices, a request for a quota information associated with a network slice selection assistance information. The process further includes transmitting, by the network side function, in response to the request, the quota information for the network slice information.

### CROSS REFERENCE TO RELATED APPLICATIONS

This patent document is a continuation of and claims benefit of priority to International Patent Application No. PCT/CN2020/084155, filed on Apr. 10, 2020. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that enable management of network slices.

In one aspect, a wireless communication method is disclosed. The method includes receiving, by a network side function operating in a wireless network in which network services are provided as one or more network slices, a request for a quota information associated with a network slice selection assistance information. The process further includes transmitting, by the network side function, in response to the request, the quota information for the network slice information.

In another aspect, another wireless communication method is disclosed. The method includes sending, by a first network side function to a second network side function, a request for slice quota information. The method further includes receiving, by the first network side function from the second network side function, the slice quota information, wherein the slice quota information is determined by the second network side function.

In another aspect, another wireless communication method is disclosed. The method includes storing, by a first network side function, slice quota information for a slice in which network services are provided. The method further includes enforcing, by the first network side function, the slice quota information.

In another aspect, another wireless communication method is disclosed. The method includes sending, from the first network side function to a second network side function, a request for slice quota information for the home network. The method further includes receiving, at the first network side function from the second network side function, a response to the request including the slice quota information for the home network. The method further includes enforcing, by the first network side function, the slice quota information for the home network according to the network slice information.

In another aspect, another wireless communication method is disclosed. The method includes determining, by a slice quota management (SQM) function, a slice quota information according to a network slice information. The method further includes sending, by the SQM function to an access and mobility management function (AMF), the slice quota information. The method further includes receiving, at the SQM function from the AMF, a notification of an overflow of the slice quota information.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement an above-described method.

These, and other, aspects are described in the present document.

### BRIEF DESCRIPTION OF DRAWINGS

FIG. 1 depicts a network architecture, in accordance with some example embodiments;

FIG. 2 depicts an example of an architecture that includes a slice quota management (SQM) function, in accordance with some example embodiments;

FIG. 3 depicts an example of a process for slice quota management in a case where the UE is non roaming, in accordance with some example embodiments;

FIG. 4 depicts a slice quota stored in slice quota management function that is sent to a network function such as the access and mobility management function to be enforced on a roaming user equipment, in accordance with some example embodiments;

FIG. 5 depicts a process for an application function to manage quota information of a slice, in accordance with some example embodiments;

FIG. 6 depicts an example of a method, in accordance with some example embodiments.

FIG. 7 depicts another example of a method, in accordance with some example embodiments;

FIG. 8 depicts yet another example of a method, in accordance with some example embodiments;

FIG. 9 depicts yet another example of a method, in accordance with some example embodiments;

FIG. 10 depicts yet another example of a method, in accordance with some example embodiments;

FIG. 11 depicts an example of a wireless communication system, in accordance with some example embodiments; and

FIG. 12 depicts an example block diagram of a portion of a radio system, in accordance with some example embodiments.

### DETAILED DESCRIPTION

Certain features are described using the example of Fifth Generation (5G) wireless protocol. However, applicability of the disclosed techniques is not limited to only 5G wireless systems.

This patent document relates to network slices which are logical networks that provide specific network capabilities and network characteristics. A network slice instance is a set of network function instances and the resources needed such as computing, storage, and networking resources, which form a deployed network slice

A network slice is a tool for operators to provide specific network capability for the operator's own service or for a third-party service. The operator needs solutions to determine slice quota information such as the maximum number of UEs registered in the network slice, the maximum number of PDU sessions within the network slice, and the maximum data rate supported by the network slice. This information is an important input to scale the network slice and provide enough resources to the network slice. This information is also used to meet any service layer agreements with third party applications.

This patent document describes techniques to manage the slice quota information for a network slice.

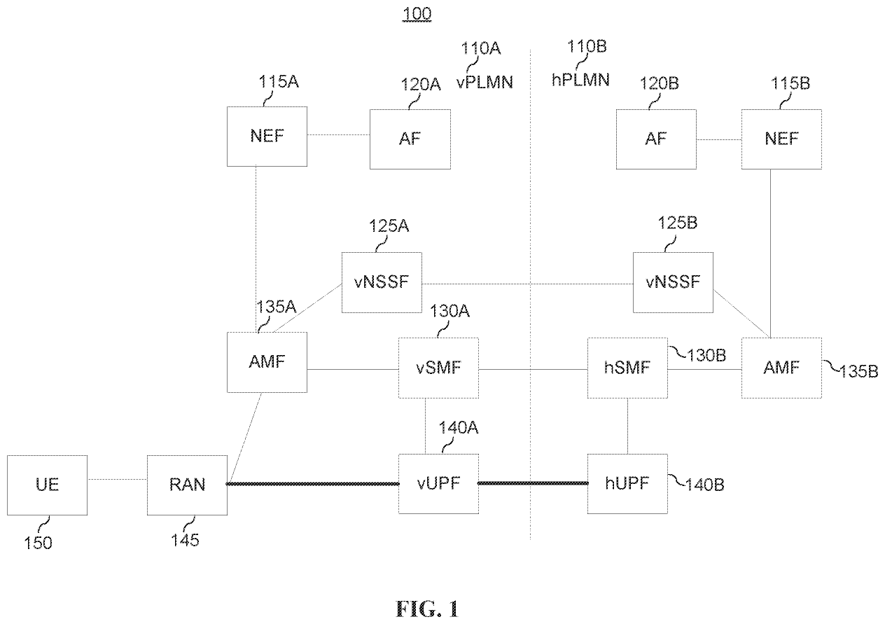

FIG. 1 depicts a network architecture, in accordance with some example embodiments. FIG. 1 depicts a user equipment (UE) 150 in communication with radio access network (RAN) 145 that is part of a visited public land mobile network (vPLMN) 110A. UE 150 is roaming from its home network, hPLMN 110B. Components of the architecture are described below.

UE 150 include devices such as cell phones, tablets, or other mobile devices.

RAN 145 includes base stations.

Access and mobility management functions (AMF) 135A in vPLMN 110A and AMF 135B in hPLMN 110B. Each AMF includes the following functionalities: registration management, connection management, reachability management and mobility management. This function also performs access authentication and access authorization. The AMF is the non-access stratum (NAS) security termination and relay the session management (SM) NAS between the UE and the SMF, etc.

Session management functions (SMF) 130A in vPLMN 110A and hSMF 130B in hPLMN 110B. Each SMF includes the following functionalities: session establishment, modification and release, UE internet protocol (IP) address allocation and management which may include optional authorization functions, selection and control of an UP function, downlink data notification, etc.

User plane function (UPF) 140A in vPLMN 110A and hUPF 140B in hPLMN 110B. Each UPF includes the following functionalities: serving as an anchor point for intra-/inter-radio access technology (RAT) mobility, packet routing and forwarding, traffic usage reporting, quality of service (QoS) handling for the user plane, downlink packet buffering and downlink data notification triggering, etc.

Network exposure function (NEF) 115A in vPLMN 110A and hNEF 115B in hPLMN 110B. Each NEF supports exposure of capability and events of the network towards the application function. A third-party application function can invoke the service provided by the network via the NEF and the NEF performs authentication and authorization of the third-party applications. The NEF also provides translation of the information exchanged with the AF and information exchanged with the internal network function.

Application function (AF) 120A in vPLMN 110A and AF 120B in hPLMN 110B. Each AF interacts with the 3GPP core network (CN) in order to provide services, for example to support: application influence on traffic routing, accessing a network exposure function, interacting with the policy framework for policy control, etc. The application functions may be trusted by the operator and can be allowed to interact directly with network functions. Application functions may not be allowed by the operator to directly access the network functions and may use an external exposure framework via the NEF to interact with network functions.

Network slice selection function (NSSF) 125A in vPLMN 110A and hNSSF 125B in hPLMN 110B. Each NSSF selects the set of network slice instances serving the UE and determines the allowed network slice selection assistance information (NSSAI) that the UE is allowed to use in the current registration area. In roaming, there is one NSSF in the vPLMN and one NSSF in the hPLMN. When determining the allowed NSSAI the vNSSF queries the hNSSF regarding whether the network slice is allowed or not.

In some example embodiments, network slice information may be NSSAI and/or single slice selection assistance information (S-NSSAI).

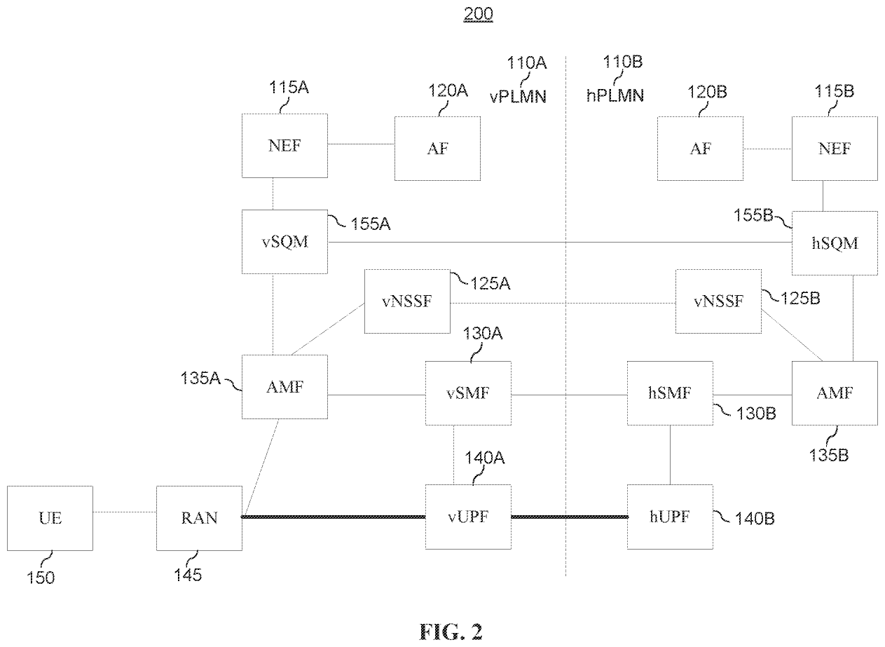

FIG. 2 depicts an example of the architecture depicted in FIG. 1 that has been modified, in accordance with some example embodiments. The architecture of FIG. 2 includes slice quota management (SQM) functions to handle the slice quota.

Slice quota management (SQM) 155A in vPLMN 110A and hSQM 125B in hPLMN 110B. Each SQM manages the slice quota for each slice. SQM store the following information per network slice: quota information indicating a maximum number of UEs that can be registered in the network slice, quota information indicating the maximum number of PDU sessions within the network slice, and quota information indicating the maximum data rate supported by the network slice.

The slice information stored at the SQM is not exclusively stored there. The SQM manages a global value of quota information and splits the global value into a local value based on a service level agreement (SLA) and sends the local value to a network function such as the AMF to enforce the quota. The SQM is notified by the network function if the local quota is overflown and the SQM may update the local quota of the network function. When the global value of the quota is overflown, the SQM notifies the operation, administration and management (OAM) function and the AF. When a UE is roaming from a hPLMN to a vPLMN, each network may have an associated SQM; a home SQM (hSQM) in the hPLMN and a visited SQM (vSQM) in the vPLMN.

The slice quota information at the in SQM can be managed by an application function via a NEF. Multiple quota values are possible for a single type per network slice, for example the AF can store different quota values of a maximum number of UEs registered in the network slice and be notified when one of the quota is overflown.

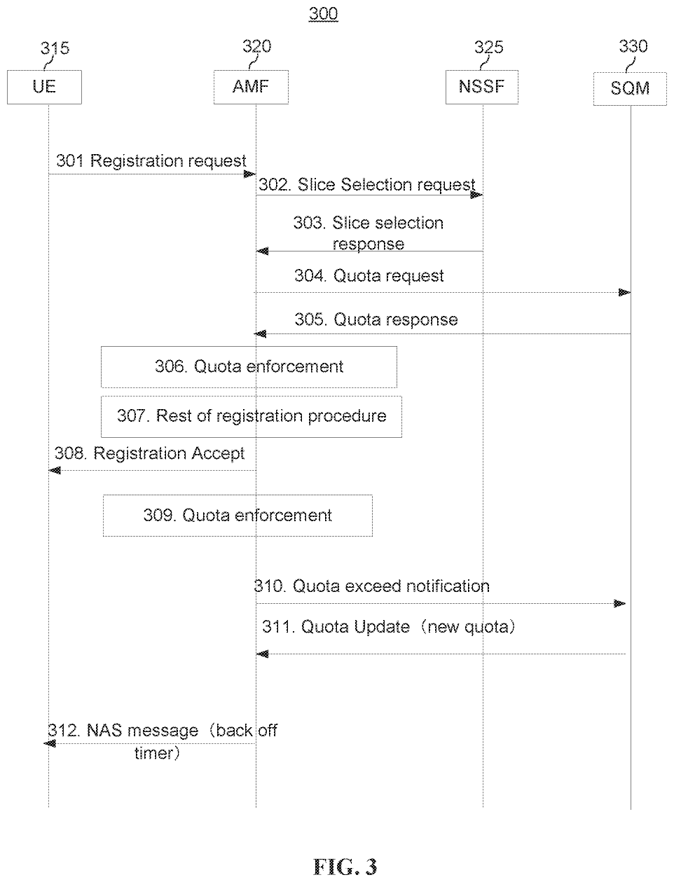

FIG. 3 depicts an example of a process for slice quota management in a case where the UE is non roaming. For example, FIG. 3 shows how the slice quota stored in an SQM is sent to network function such as AMF to be enforced.

At 301, the UE 315 sends a registration request message to the AMF 320. In the message the UE includes a requested single NSSAI (S-NSSAI).

At 302, the AMF 320 sends a slice selection request to NSSF 325 to select a network slice for the UE 315. The AMF 320 provides the requested S-NSSAI, a subscribed S-NSSAI, and the UE location to the NSSF 325.

At 303, the NSSF 325 determines the allowed NSSAI for the UE 315. The allowed NSSAI is a list of NSSAIs that the UE is allowed to use in the current registration area. The NSSF returns the allowed NSSAI to the AMF. For each S-NSSAI in the allowed NSSAI, the NSSF includes an indication whether the S-NSSAI is subject to quota enforcement.

At 304, if there is an S-NSSAI in the allowed NSSAI subject for quota enforcement, and the AMF has no local quota information for the S-NSSAI, the AMF sends a message to the SQM for the quota information of the S-NSSAI. The request message may include the S-NSSAI, AMF capability information, and/or an AMF identifier.

At 305, the SQM determines local quota information for the AMF and returns the local quota information to the AMF. The AMF stores local quota information of the S-NSSAI. When the AMF set is deployed, the SQM determines the local quota information per AMF set.

For the first UE registered in the network slice within the AMF, 304 and 305 are performed. If the AMF has already stored the local quota information of the S-NSSAI and the local quota information is not overflown, the AMF has no need to query the SQM again. When the SQM determines to update the quota information, the SQM subscribes and sends update information to the associated AMFs.

At 306, when local quota information is stored in the AMF, the AMF enforces the quota information. If the maximum number of UEs does not exceed a maximum number for the network slice, the AMF continues to register additional UEs. If the maximum number of UEs does exceed a maximum number for the network slice, the AMF rejects to register additional UE.

At 307, the AMF continues the registration procedure.

At 308, the AMF returns a registration acceptance message to the UE.

At 309, the AMF continues to enforce the slice quota as detailed below.

The AMF keeps track of the number of registered UEs in the network slice (the S-NSSAI is within the allowed NSSAI of the UE). The AMF updates the number when a UE is newly registered at the AMF, or deregistered at the AMF, or when the UE is handed over to a new AMF or handed over to the AMF from another AMF. Each UE context at the AMF contains the allowed NSSAI. The number of UEs registered at the AMF for the network slice is compared to a maximum number allowable from the quota information.

The AMF keeps track of the number of PDU sessions in the network slice (the PDU session is associated with the S-NSSAI). The AMF updates the number of sessions if a PDU session is newly established or released in the AMF, or the PDU session is handed over to a new AMF or handed to the AMF from another AMF. Each UE context in the AMF contains the PDU session identifier and the associated S-NSSAI. In some implementations, when the UE de-activates a PDU session due to radio resource restrictions, the AMF does not need to update the number of PDU sessions being tracked. The number of PDU sessions for the network slice is compared to a maximum allowable number of PDU sessions from the quota information.

The AMF keeps track of the data rate used by the network slice as described below and is compared to the maximum data rate supported by the network slice from the quota information. The AMF has the maximum data rate for the network slice and for each UE registered at the network slice. The maximum data rate per slice for each UE may be from UE subscription data or from a PCF (policy control function). The AMF sums up the data rate of the network slice for all UEs in the network slice for the UE is registered in the network slice which have established PDU sessions in the network slice and are in a connected state where a radio resource is allocated for the PDU sessions. Alternatively, the RAN may report the maximum data rate of the network slice on a per UE basis or a per slice basis to the AMF when a new QoS flow is established or released or updated within the slice so the AMF updates the tracking of the quotas.

At 310, when quota information is overflown, the AMF sends notification to the SQM. The notification message includes the AMF identifier and the quota type.

At 311, the SQM may adjust the quota information for the AMF. The SQM may return new quota information indicating additional quota has been allowed by the AMF, or may return information indicating no additional quota will be allowed by the AMF. The SQM may also update new quota information to other AMF s.

At 312, if new quota is received, the AMF performs quota enforcement as in 309. If no additional quota is allowed, the AMF sends a NAS message with a cause value indicating the network slice is overloaded. The NAS message may also include a back-off timer to the UE associated with the slice. The UE should not initiate a service request or registration request towards the slice before the back-off timer expires. The following are some examples showing how to notify the UE.

a) During the UE registration procedure, if any of the quota information of the requested S-NSSAI is overflown, the AMF sends a registration reject message to the UE, in which the reject NSSAI includes the requested S-NSSAI. The cause value is set to “S-NSSAI is not available in the current registration area”. A back-off timer may also be sent to the UE so the UE will not request the same S-NSSAI before the back-off timer expires if the UE is within the same registration area. When the UE moves outside of the registration area the UE initiates a registration procedure and can request the S-NSSAI again. If the AMF receives new quota information of the S-NSSAI from the SQM, the AMF may send a new allowed NSSAI containing the S-NSSAI in a UE configuration update message to the UE so the UE can use this S-NSSAI again.

b) During a PDU session establishment/modification procedure, if the AMF determines that the maximum number of PDU sessions in the network slice or the maximum data rate supported by the network slice has been overflown, the AMF sends a NAS message to the UE, including a back-off timer and the NAS message received from the UE. The UE will not send the same NAS message before the back-off timer expires.

At any time after 304, the SQM may request that the AMF report the usage of the network slice including number of UEs registered, number of PDU sessions, and the data rate used by the slice. A report may be sent from the AMF once, periodically, or intermittently.

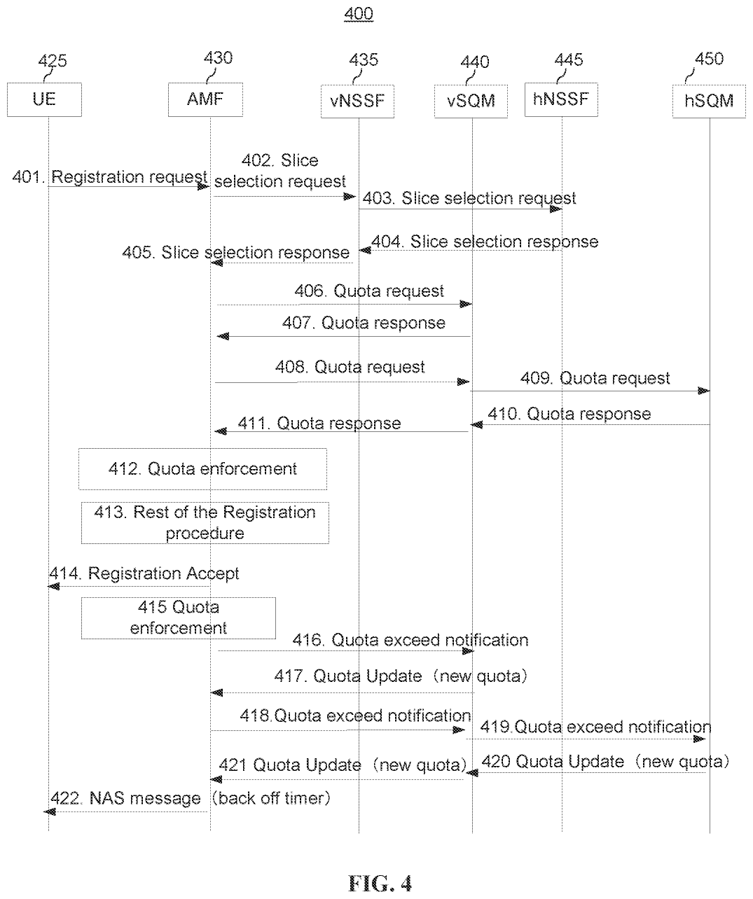

FIG. 4 depicts a slice quota stored in the SQM that is sent to a network function such as the AMF to be enforced on a roaming UE.

At 401, the UE initiates a registration request to the AMF including a requested S-NSSAI.

At 402, the AMF sends request to the vNSSF to select a network slice for the UE. The AMF provides the requested S-NSSAI, the subscribed S-NSSAI and the UE location to the vNSSF.

At 403, the vNSSF determines the allowed NSSAI for the UE. The allowed NSSAI is a list of S-NSSAIs that the UE is allowed to use in the current registration area. If the vNSSF does not cache mapping slice information for the hPLMN for the allowed NSSAI, the vNSSF sends a slice selection request to the hNSSF in the home PLMN (hPLMN). The message may include the allowed NSSAI.

At 404, the hNSSF determines and returns to the vNSSF the mapping slice information in the hPLMN for the allowed NSSAI. For each S-NSSAI in the mapped slice information in the HPLMN, the hNSSF includes an indication whether the mapped S-NSSAI is subject to quota enforcement

At 405, the NSSF returns to the AMF the allowed NSSAI together with the mapping slice information in the HPLMN. For each S-NSSAI in the allowed NSSAI, the NSSF also includes an indication whether the S-NSSAI is subject to quota enforcement. For each S-NSSAI in the mapped slice information in the HPLMN, the vNSSF includes an indication whether the mapped S-NSSAI is subject for quota enforcement

At 406, if the S-NSSAI in the allowed NSSAI is subject to quota enforcement, and the AMF has no local quota information for this S-NSSAI, the AMF requests from the SQM in the vPLMN the quota information of the S-NSSAI. A request message may include the S-NSSAI, the AMF capability information, and/or an AMF identifier.

At 407, the SQM in the VPLMN determines and returns to the AMF the local quota information for the AMF. The AMF stores the local quota information of the S-NSSAI in the vPLMN. When the AMF set is deployed, the SQM determines the local quota information per AMF set.

At 408, if the S-NSSAI in the mapped slice information in the HPLMN is subject to quota enforcement, and the AMF has no local quota information for this mapped S-NSSAI, the AMF requests from the vSQM the quota information of the mapped S-NSSAI. The request message may include the S-NSSAI in the hPLMN, the AMF capability information, an AMF identifier, and/or a home PLMN identifier.

At 409, the vSQM forwards the request to the hSQM in the home PLMN based on the home PLMN identifier.

At 410, the hSQM determines the local quota information for the AMF and returns the local quota information to the vSQM. The hSQM may determine the local quota information based on an inter-PLMN service level agreement. When the AMF set is deployed, the SQM determines the local quota information per AMF set.

At 411, the vSQM forwards the local quota information for the AMF. The AMF stores the local quota information of the S-NSSAI in the hPLMN

For the first UE registered in the network slice within the AMF, 406 and 411 are performed. If the AMF already stores the local quota information of the S-NSSAI in the vPLMN or in the hPLMN the AMF does not need to query the vSQM or hSQM again.

At 406 and 407, when the vSQM determines to update the quota information the vSQM sends update information to the associated AMF.

At 408 and 411 when the hSQM determines to update the quota information the hSQM sends update information to the associated AMF directly or via the vSQM.

The AMF may also query the quota information from the hSQM without involving the vSQM. In this case step 408 is sent to the hSQM, and 410 is sent to the AMF.

At 412, when local quota information is stored in the AMF, the AMF enforces the quota information for each S-NSSAI in the vPLMN or for each S-NSSAI in the hPLMN, or for both. If the maximum number of UEs in the network slice does not exceed the quota, the AMF continues to register additional UEs. If the maximum number of UEs does exceed a maximum number for the network slice, the AMF rejects to register the additional UE.

At 413, the AMF continues the rest of the registration process.

At 414, the AMF returns the registration accept message to the UE.

At 415, the AMF continues to enforce the slice quota for each S-NSSAI in the vPLMN and/or for each S-NSSAI in the hPLMN or for both as detailed below.

The AMF keeps track of the number of registered UEs in the network slice (the S-NSSAI is within the allowed NSSAI of the UE, and/or the mapped S-NSSAI in the hPLMN is within the corresponding mapped NSSAI in the hPLMN for the allowed NSSAI). The AMF updates the number of UEs when an additional UE is registered at the AMF, or a UE is deregistered at the AMF, or when the UE is handed over to a new AMF or handed to from another AMF. Each UE context in the AMF contains the allowed NSSAI and corresponding mapped NSSAI in hPLMN. The number of UEs registered at the AMF for the network slice is compared to a maximum number allowable from the quota information

The AMF keeps track of the number of PDU sessions in the network slice (PDU sessions associated with the S-NSSAI in the vPLMN and keeps track of the number of home routed PDU sessions in the network slice (PDU sessions associated with the mapped S-NSSAI in the hPLMN). The AMF updates the number of PDU sessions when a new PDU session is established or released in the AMF, or a PDU session is handed over to the AMF from another AMF or handed to the AMF from another AMF. Each UE context in the AMF contains a PDU session identifier and an associated S-NSSAI in the vPLMN and a correspondingly mapped NSSAI in the hPLMN. When the UE de-activates a PDU session because of the radio resource, the AMF does not need to update the number of PDU sessions tracked. The number of PDU sessions for the network slice is compared to a maximum allowable number of PDU sessions from the quota information.

The AMF keeps track of the data rate used by the network slice as described below and is compared to the maximum data rate supported by the network slice from the quota information. For each UE registered at the network slice, the AMF has the maximum data rate of the network slice. The maximum data rate per slice may be determined from the subscription data or from a policy control function (PCF). The AMF can sum up the data rate for all the UEs registered in the network slice with established PDU sessions in the network slice and in a connected state which means a radio resource is allocated for the PDU sessions. For an S-NSSAI in the hPLMN, the AMF may calculate the UE which has established home routed PDU sessions. Alternatively, the RAN may report the maximum data rate of the network slice on a per UE basis or a per slice basis to the AMF when a new QoS flow is established or released or updated so that the AMF updates the tracking of the quotas.

At 416, when quota information of an S-NSSAI in the vPLMN is overflown, the AMF sends a notification message to the vSQM. The notification message includes the AMF identifier and the quota type.

At 417, the vSQM may adjust the quota information for the AMF. The vSQM may send a message indicating an additional quota allocated to the AMF or may send no additional quota to the AMF.

At 418, when quota information of an S-NSSAI in the hPLMN is overflown, the AMF sends a notification message to the vSQM. The notification message includes the AMF identifier and the quota type, and/or the home PLMN identifier.

At 419, the vSQM forwards the notification to the hSQM.

At 420, the hSQM may adjust the quota information for the AMF. The hSQM may send a message indicating an additional quota to the vSQM or may send no additional quota to the vSQM. The hSQM may also update the quota information without involving the vSQM. In this case 420 is sent to the AMF directly

At 421, the vSQM sends a quota update message to the AMF.

.At 422, if new quota is received, the AMF performs the quota enforcement 412. If no new additional quota is received, the AMF sends a NAS message with a cause value indicating the network slice is overloaded. The NAS message may also include a back-off timer associated with the slice to the UE. The UE should not initiate service request or registration request towards this slice before the back-off timer expires. The followings are some examples showing how to notify the UE.

a) During the UE registration process, if any parameter of the quota information of the requested S-NSSAI is overflown (e.g., number of UEs registered, number of PDU sessions, data rate), the AMF sends a registration reject message to the UE in which the rejected NSSAI includes the requested and rejected S-NSSAI. The cause of the rejection is set to “S-NSSAI is not available in the current registration area”. A back-off timer may be sent to the UE so the UE will not request the same S-NSSAI before the back-off timer expires if the UE is within the same registration area. When the UE moves outside of the registration area, the UE initiates another registration and can request the S-NSSAI again. If the AMF receives new quota information for the S-NSSAI from the SQM, the AMF may send a new allowed NSSAI containing the S-NSSAI in a UE configuration update message to the UE so the UE can use the S-NSSAI again.

b) During a PDU session establishment/modification procedure, if the AMF determines that the quota including the maximum number of PDU sessions in the network slice or the maximum data rate supported by the network slice has been overflown, the AMF sends a NAS message to the UE, including a back-off timer and a NAS message received from the UE. So the UE will not send same NAS message before the back-off timer expires.

At any time after 406 or 409, the vSQM or hSQM may request that the AMF report the usage of the network slice including number of UEs registered, number of PDU sessions, and the data rate used by the slice. The report can be sent once, periodically, or intermittently.

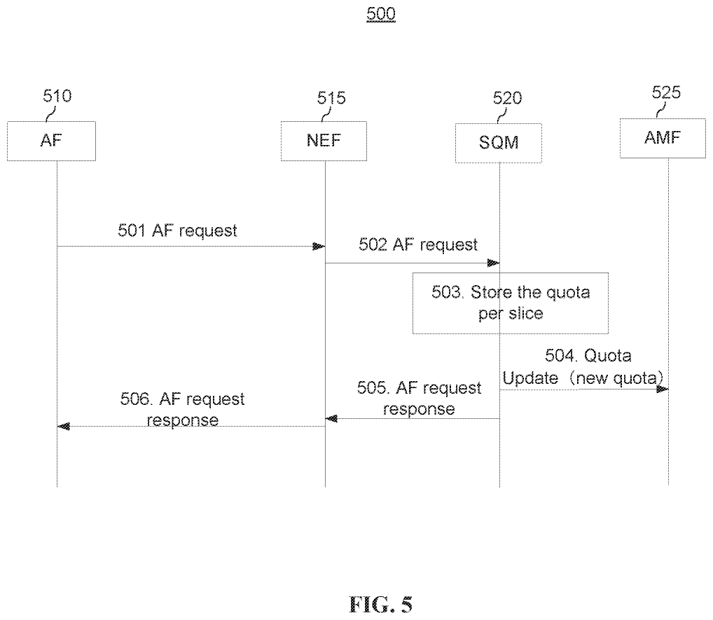

FIG. 5 depicts a process for an application function (AF) to manage quota information of a slice stored at the SQM.

At 501, the AF sends a request to update the quota information stored in SQM. If the AF is not trusted the AF request is sent to a NEF. The message includes an AF identifier, an S-NSSAI and the associated quota information.

At 502, the NEF performs authorization for the AF. If successful, the NEF forwards the AF request to the SQM.

At 503, the SQM stores new quota information for the S-NSSAI.

At 504, the SQM updates the quota information of the S-NSSAI in the AMF. In roaming case this message may be sent directly to the AMF or via vSQM.

At 505, the SQM sends to the NEF the request response.

At 506, the NEF sends the request response to the AF.

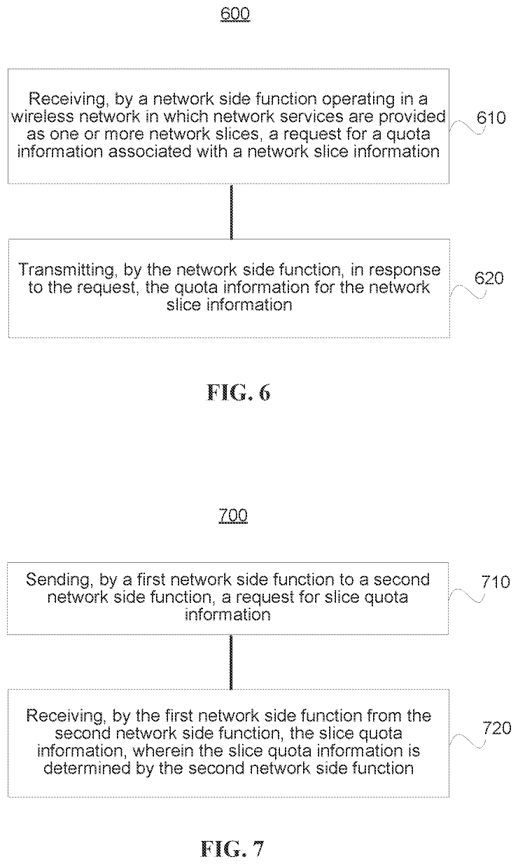

FIG. 6 depicts an example of a method, in accordance with some example embodiments. At 610, the method includes receiving, by a network side function operating in a wireless network in which network services are provided as one or more network slices, a request for a quota information associated with a network slice selection assistance information. At 620, the method includes transmitting, by the network side function, in response to the request, the quota information for the NSSAI.

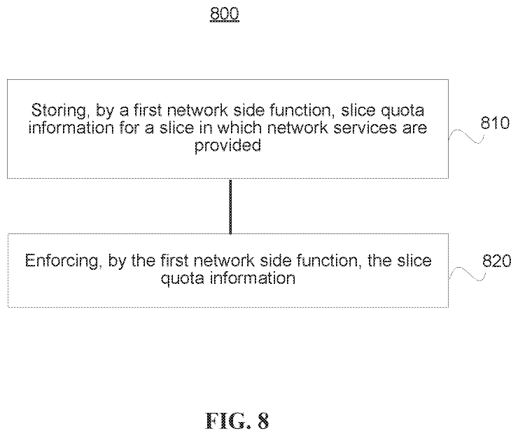

FIG. 7 depicts another example of a method, in accordance with some example embodiments. At 710, the method includes sending, by a first network side function to a second network side function, a request for slice quota information. At 720, the method includes receiving, by the first network side function from the second network side function, the slice quota information, wherein the slice quota information is determined by the second network side function.

FIG. 8 depicts another example of a method, in accordance with some example embodiments. At 810, the method includes storing, by a first network side function, slice quota information for a slice in which network services are provided. At 820, the method includes enforcing, by the first network side function, the slice quota information.

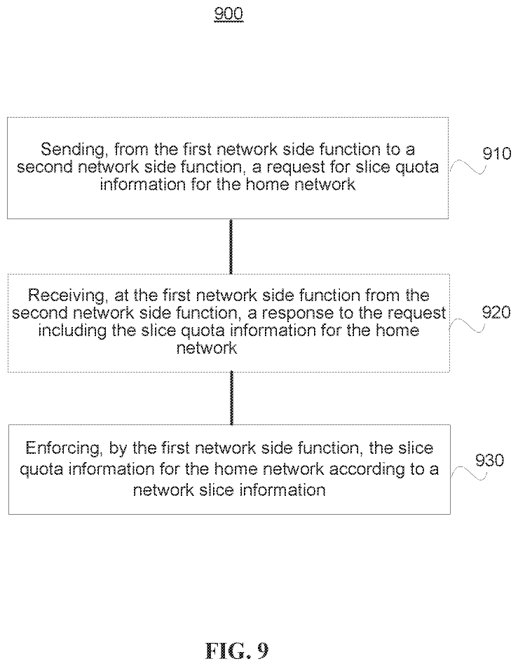

FIG. 9 depicts another example of a method, in accordance with some example embodiments. At 910, the method includes sending, from the first network side function to a second network side function, a request for slice quota information for the home network. At 920, the method further includes receiving, at the first network side function from the second network side function, a response to the request including the slice quota information for the home network. At 930, the method includes enforcing, by the first network side function, the slice quota information for the home network according to the NSSAI.

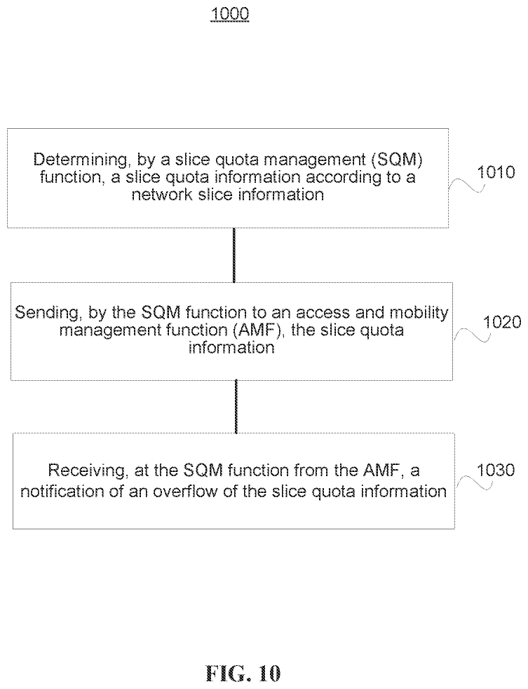

FIG. 10 depicts another example of a method, in accordance with some example embodiments. At 1010, the method includes determining, by a slice quota management (SQM) function, a slice quota information according to a NSSAI. At 1020, the method includes sending, by the SQM function to an access and mobility management function (AMF), the slice quota information. At 1030, the method includes receiving, at the SQM function from the AMF, a notification of an overflow of the slice quota information.

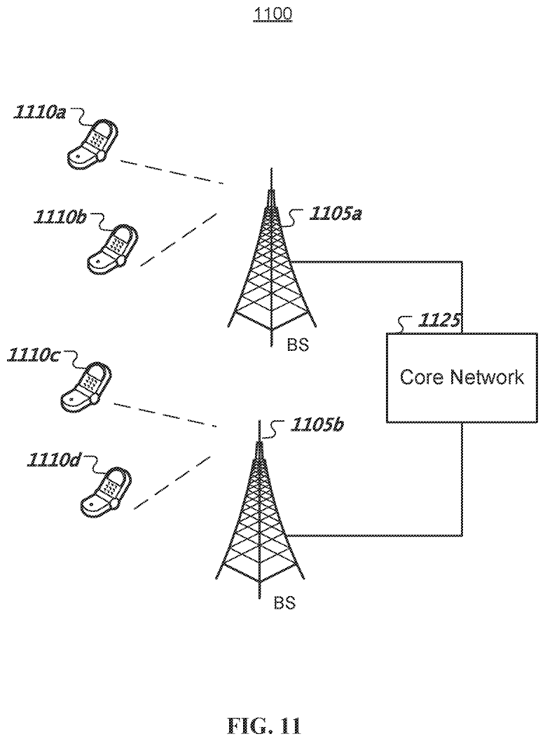

FIG. 11 shows an example of a wireless communication system 1100 where techniques in accordance with one or more embodiments of the present technology can be applied. A wireless communication system 1100 can include one or more base stations (B Ss) 1105a, 1105b, one or more wireless devices 1110a, 1110b, 1110c, 1110d, and a core network 1125. A base station 1105a, 1105b can provide wireless service to wireless devices 1110a, 1110b, 1110c and 1110d in one or more wireless sectors. In some implementations, a base station 1105a, 1105b includes directional antennas to produce two or more directional beams to provide wireless coverage in different sectors.

The core network 1125 can communicate with one or more base stations 1105a, 1105b. The core network 1125 provides connectivity with other wireless communication systems and wired communication systems. The core network may include one or more service subscription databases to store information related to the subscribed wireless devices 1110a, 1110b, 1110c, and 1110d. A first base station 1105a can provide wireless service based on a first radio access technology, whereas a second base station 1105b can provide wireless service based on a second radio access technology. The base stations 1105a and 1105b may be co-located or may be separately installed in the field according to the deployment scenario. The wireless devices 1110a, 1110b, 1110c, and 1110d can support multiple different radio access technologies. The techniques and embodiments described in the present document may be implemented by the base stations of wireless devices described in the present document.

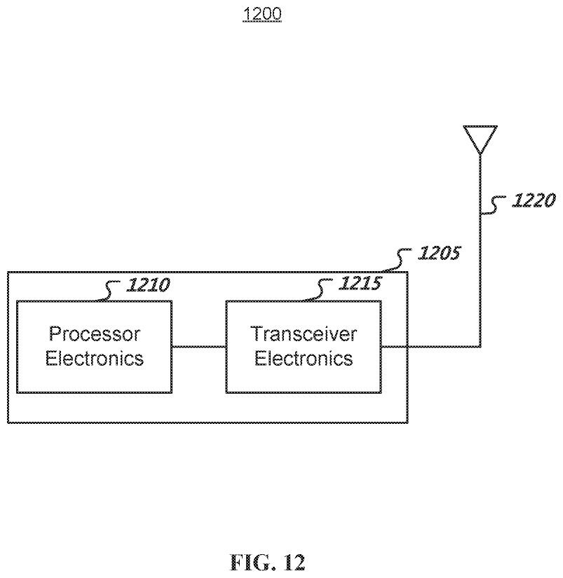

FIG. 12 is a block diagram representation of a portion of a radio station in accordance with one or more embodiments of the present technology can be applied. A radio station 1205 such as a base station or a wireless device (or UE) can include processor electronics 1210 such as a microprocessor that implements one or more of the wireless techniques presented in this document. The radio station 1205 can include transceiver electronics 1215 to send and/or receive wireless signals over one or more communication interfaces such as antenna 1220. The radio station 1205 can include other communication interfaces for transmitting and receiving data. Radio station 1205 can include one or more memories (not explicitly shown) configured to store information such as data and/or instructions. In some implementations, the processor electronics 1210 can include at least a portion of the transceiver electronics 1215. In some embodiments, at least some of the disclosed techniques, modules or functions are implemented using the radio station 1205. In some embodiments, the radio station 1205 may be configured to perform the methods described herein.

It will be appreciated that the present document discloses techniques that can be embodied in various embodiments to establish and manage multicast sessions in various scenarios. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A wireless communication method, comprising:
receiving, by a network side function operating in a wireless network in which network services are provided as one or more network slices, a request for a quota information associated with a network slice information; and
transmitting, by the network side function, in response to the request, the quota information for the network slice information.

2. The method of claim 1, wherein the request is received from an access and mobility function (AMF) in the wireless network.

3. The method of claim 1, wherein the request is received from a network side function other than an AMF.

4. The method of claim 1, wherein the quota information comprises a limit on a number of wireless devices that are allowed to be registered for a network slice identified by the network slice information.

5. The method of claim 1, wherein the quota information comprises a limit on a number of protocol data unit (PDU) sessions operable within a network slice identified by the network slice information.

6. The method of claim 1, wherein the quota information comprises a maximum data rate supported by a network slice identified by the network slice information.

7. A wireless communication method, comprising:
sending, by a first network side function to a second network side function, a request for slice quota information; and
receiving, by the first network side function from the second network side function, the slice quota information, wherein the slice quota information is determined by the second network side function.

8. The method of claim 7, further comprising:
receiving, at a first network side function, information that the network slice is subject to a quota management.

9. The method of claim 7, wherein the request includes one or more of a network slice information, a capability of the first network side function, or an identity of the first network side function.

10. The method of claim 9, wherein the first network side function stores local quota information of the network slice information.

11. A wireless communication method, comprising:
storing, by a first network side function, slice quota information for a slice in which network services are provided; and
enforcing, by the first network side function, the slice quota information.

12. The method of claim 11, further comprising:
notifying, by the first network side function, a second network side function of an overflow of the slice quota information; and
sending, by the first network side function to a user equipment (UE), upon the overflow a back-off timer value according to a network slice information.

13. A wireless communication method, comprising:
sending, from a first network side function to a second network side function, a request for slice quota information for a home network;
receiving, at the first network side function from the second network side function, a response to the request including the slice quota information for the home network; and
enforcing, by the first network side function, the slice quota information for the home network according to the network slice information.

14. The method of claim 13, further comprising:
receiving, at a first network side function, information that a home network is subject to a quota management according to a network slice information.

15. The method of claim 13, wherein the first network side function is an access and mobility management function (AMF) and the second network side function is a slice quota management (SQM) function.

16. The method of claim 13, wherein the enforcing comprises accepting a registration of a user equipment at a network slice when a total number of user equipment served by the network slice is less than or equal to a maximum number, and denying the registration of the user equipment when the total number of user equipment served by the network slice exceeds the maximum number.

17. A wireless communication method, comprising:
determining, by a slice quota management (SQM) function, a slice quota information according to a network slice information;
sending, by the SQM function to an access and mobility management function (AMF), the slice quota information; and
receiving, at the SQM function from the AMF, a notification of an overflow of the slice quota information.

18. The method of claim 17, wherein the slice quota information comprises a limit on a number of wireless devices that are allowed to be registered for a network slice identified by the network slice information, wherein the limit includes a maximum number of user equipment.

19. The method of claim 17, wherein the slice quota information includes a maximum number of protocol data unit (PDU) sessions served by the network slice identified by the network slice information.

20. The method of claim 17, wherein the slice quota information includes a maximum data rate supported by the network slice identified by the network slice information.
